(19) United States
(12) Patent Application Publication
(10) Pub. No.: US 2011/0195938 A1
(43) Pub. Date: Aug. 11, 2011

(54) PROCESS FOR PREVENTING OR MITIGATING BIOFOULING

(75) Inventors: Kenneth G. Wunch, The Woodlands, TX (US); Joseph E. Penkala, Houston, TX (US)

(73) Assignee: Baker Hughes Incorporated, Houston, TX (US)

(21) Appl. No.: 13/019,586

(22) Filed: Feb. 2, 2011

Related U.S. Application Data
(60) Provisional application No. 61/302,604, filed on Feb. 9, 2010.

(51) Int. Cl. A01N 35/00; A01N 57/20; C09K 8/524

(52) U.S. Cl. 514/129; 514/701; 507/263; 507/137

(57) ABSTRACT

Biofouling may be prevented or at least mitigated by employing a cinnamaldehyde additive to augment the affect of the conventional biocide. Exemplary cinnamaldehyde additives include, but are not limited to, cinnamaldehyde, cinnamic acid and cinnamyl alcohol. A cinnamaldehyde additive by itself, in some applications, may also inhibit biofouling.

### CROSS REFERENCE TO RELATED APPLICATION

This application claims priority from the U.S. Provisional Patent Application Ser. No. 61/302,604 filed Feb. 9, 2010; and which application is incorporated herein by reference in its entirety.

### BACKGROUND OF THE INVENTION

1. Field of the Invention

The present invention relates to methods and compositions for inhibiting bacterial and/or algael growth in fluids and/or surfaces.

2. Background of the Art

Throughout the world, there are many different types of industrial water systems. Industrial water systems include water used for cooling and/or energy generation. Biofouling can occur even in industrial water systems treated with the best water treatment programs currently available. For purposes of this patent application, “biofouling” is defined as “the deposition of a biological material on or near a surface in contact with industrial water and/or any diminution of system efficiency due to the accumulation of a biological material within an industrial system that employs industrial water”.

If industrial water systems are not treated for microbial fouling control, then they may become subject to heavy biofouling. Such fouling may have a negative impact on an industrial water system and resultant negative economic consequences on the processes utilizing them.

In addition to industrial water systems, biofouling may be a substantial problem in the exploration for and production of oil and gas. Aqueous fluids including but not limited to drilling fluids, production fluids, formation fluids, and the like maybe subject to biofouling.

Sources of bacterial microorganisms that may cause biofouling in industrial water systems are numerous and may include, but are not limited to, air-borne contamination, water make-up, process leaks and improperly cleaned equipment. Also bacteria that are indigenous to the water used. These microorganisms can establish microbial communities on any wetted or semi-wetted surface of a water system.

### SUMMARY OF THE INVENTION

The invention is, in one aspect, a process for preventing or mitigating the occurrence of biofouling comprising using a cinnamaldehyde additive as a biocide.

In an aspect, the invention is a process for preventing or mitigating the occurrence of biofouling comprising augmenting applications of conventional biocides using a cinnamaldehyde additive.

In another aspect, the invention is a process for preventing or mitigating the occurrence of biofouling comprising treating an industrial water system with a biocide system comprising a first component and a second component, wherein the first component is a conventional biocide and the second component is a cinnamaldehyde additive.

In yet another aspect, the invention is a process for preventing or mitigating the occurrence of biofouling comprising treating an industrial water system with a biocide system comprising a first component and a second component, wherein the first component is an inert synergistic component and the second component is a cinnamaldehyde additive.

In still another aspect, the invention is a process for preventing or mitigating the occurrence of biofouling comprising treating an industrial water system with a biocide additive comprising the cinnamaldehyde additive and no conventional biocide or synergistic component.

In still another aspect, the invention is a biocide composition useful for preventing or mitigating the occurrence of biofouling comprising a biocide and a cinnamaldehyde additive.

In another aspect, the invention is a biocide composition useful for preventing or mitigating the occurrence of biofouling comprising an inert synergistic component and a cinnamaldehyde additive.

An aspect of the invention is the use of plant extracts or synthetic copies of the plant extract, such as cinnamaldehyde, vanillin, eugenol, and capsaicin; to prevent or mitigate biofouling.

In another aspect, the invention is a process for dispersing biofilms, and stabilizing compositions including gels, friction reducers, and completions fluids; during the production of oil and gas comprising introducing a cinnamaldehyde additive into production and/or drilling fluids.

In still another aspect, the invention is a process for treating a completion or production fluid comprising introducing a cinnamaldehyde additive into the completion or production fluid wherein the cinnamaldehyde additive functions to compatibilize: the phases of the completion or production fluid, a friction reducer with a production fluid, and combinations there of.

### DESCRIPTION OF THE PREFERRED EMBODIMENTS

For the purposes of this application, the term “industrial water systems” also includes fluids associated with the exploration for and production of oil and gas. Industrial water systems include, but are not limited to cooling water, especially those systems that include cooling towers; industrial cleaning processes; and process water preparation systems. In the case of these later systems, examples could include process water make-up systems for the production of paper, sugar, chemicals, and for use in mining operations.

Exemplary industrial water systems in the field of exploration for and production of oil and gas include aqueous drilling fluids, fluids used for secondary and tertiary recovery, fracture fluids, and the like. Even some “oil based” fluids have sufficient water to be subject to biofouling and may be treated according to some embodiments of the methods of the disclosure.

Biofouling of industrial water systems may occur utilizing at least two different mechanisms. One of these mechanisms is the generation of biofilms. Biofilms are produced when bacterial colonies develop on the surfaces of the industrial water systems. For example, in a cooling tower biofilms may be developed on the sides of the tower or within the piping inside the tower.

In an oil field, biofilms may occur on the surfaces of drilling equipment, pipelines, secondary equipment such as desalters, and even on the surfaces of the geological formation itself. Exopolymeric substances secreted from the microorganisms aid in the formation of biofilms as the microbial communities develop on the surface. These biofilms are complex ecosystems that establish a means for concentrating nutrients and offer protection for growth.

Although they are a problem in themselves, biofilms may cause other problems as well. Biofilms can accelerate scale, corrosion, and other fouling processes. Not only do biofilms contribute to reduction of system efficiencies, but they also provide an excellent environment for microbial proliferation that can include pathogenic bacteria.

The second mechanism is the mass accumulation of biological materials. Biological masses can block pipes and restrict the porosity of the geological formations producing oil and gas. Pipelines and secondary equipment can also be subjected to a restricted flow condition.

Several factors may contribute to the problem of biofouling and govern its extent. Water temperature; water pH; organic and inorganic nutrients, growth conditions such as aerobic or anaerobic conditions, and in some cases the presence or absence of sunlight, etc. can, in some embodiments, play an important role. These factors may also help in elucidating what types of microorganisms might be present in the water system.

Many different approaches are utilized for the control of biological fouling in industrial processes. The most commonly used method is the application of biocidal compounds to the process waters. The biocides applied may be oxidizing or non-oxidizing in nature. Oxidizing biocides such as chlorine gas, hypochlorous acid, bromine derived biocides, and other oxidizing biocides are widely used in the treatment of industrial water systems.

For example, in one embodiment the conventional biocide may be a halogen-based biocide which readily oxidizes in aqueous solution. In this embodiment, the conventional biocide may release hypochlorous acid into the aqueous solution which may quickly convert to hypobromous acid. Hypobromous acid may be an effective biocide when the system pH is above 7.5, and when nitrogen-based contaminants/odorants (i.e., ammonia/amines) are present.

In another embodiment, the conventional biocide may include trichloroisocyanuric acid or a derivative thereof. In a further embodiment, the biocide may include sodium dichloro-s-triazinetrione (trichloroisocyanuric acid) and sodium bromide.

Conventional biocides, in some embodiments, may include, but are not limited to, isothiazolone, bleaches, and hydantoins. In an example of such an embodiment, the conventional biocide comprises a stabilized halogen compound including stabilized bromine, fluorine, iodine, and chlorine. Other chlorine release compounds, such as chlorinated isocyanurates, hypochlorites, and chlorinated hydantoins may be used with still other embodiments.

Quaternary ammonium compounds are one class of primarily non-oxidizing conventional biocides. These are cationic surface active chemicals which may be effective against algae and bacteria at alkaline pH. These may include, for example, azole materials, including triazoles and imidazoles. Also included in this class are benzalkonium chloride or carbonate; didecyldimethylammonium chloride; tebuconazole; and propiconazole.

The biocide component of this invention may include conventional biocides that exhibit a synergistic effect when added to a fluid stream with a peracetic acid. Examples of such suitable non-oxidizing conventional biocides include benzisothiazolin, carbonimidic dibromide, 1,4-Bis(bromoacetoxy)-2-butene and β-bromo-β-nitrostyrene.

A group of specialized dithiocarbamates, as disclosed by U.S. Pat. No. 5,089,619, which is incorporated herein by reference in its entirety, may also be used as the conventional biocide in some embodiments of the disclosure.

Another group of conventional biocides which may be used in certain embodiments of the disclosure include formaldehyde, p-formaldehyde, and glutaraldehyde. Hydroxyalkylaminoalkanols, e.g. 2-hydroxymethyl-amino methanol, thiocarbamates, thiocyanates, isothiazolones and the like may be used with some embodiments.

Still another group of suitable biocides include isothiazolin-3-ones such as 2-methyl-4-isothiazolin-3-one, 2 ethyl-4-isothiazolin-3-one, 2-propyl-4-isothiazolin-3-one, 2-butyl-4-isothiazolin-3-one, 2-amyl-4-isothiazolin-3-one, 5-chloro-2-methyl-4-isothiazolin-3-one, 5-bromo-2-methyl-4-isothiazolin-3-one, 5-iodo-2-methyl-4-isothiazolin-3-one, 5-chloro-2-butyl-4-isothiazolin-3-one, 5-bromo-2-ethyl-4-isothiazolin-3-one, 5-iodo-2-amyl-4-isothiazolin-3-one and similar analogs and homologs within the genus.

Complexed biocidal metals may be used as conventional biocides in some embodiments of the disclosure. For example, in the case of copper, suitable relatively insoluble material reactive with complexing agents include cuprous oxide, cupric oxide, copper hydroxide, copper carbonate, copper basic carbonate, copper oxychloride, copper-8-hydroxyquinolate, copper dimethyl dithiocarbamate, copper omadine, copper borate, copper metal byproducts, copper sulfate, copper fluoroborate, copper fluoride, copper formate, copper acetate, copper bromide, copper iodide, copper basic phosphate, copper basic phosphor-sulfate, copper basic nitrate, combinations of these, and the like. Copper basic carbonate, which may be represented by the simplified formula Cu(OH)₂—CuCO(₃), is an example of one source of relatively insoluble copper.

Still other conventional biocides may be used with embodiments of the application. Exemplary biocides include, but are not limited to, metaborate, sodium dodecylbenzene sulphonate, sodium benzoate, thione, bromonitropropanediol, bromohydroxyacetophenone, dibromodicyanobutane, sodium orthophenylphenate, dodecylguanidine hydrochloride, oxazolidines, adamantanes, dibromonitrilopropionamide, tetrakis hydroxymethyl phosphonium sulfate, and chloromethylphenol. Any conventional biocide, known or unknown, may be used with certain embodiments of the disclosure.

In addition to biocides, the cinnamaldehyde additives of the disclosure may be used with inert synergistic components. The inert synergistic components are compounds that by themselves do not act as a potent biocide, but may be combined synergistically with cinnamaldehyde additives to form an effective biocide. Examples of inert synergistic components useful with the disclosure include but are not limited to sodium nitrite, sodium molybdate, and anthraquinone. These compounds may be used in the same ratios as the conventional biocides.

The biocide compositions of the application included a cinnamaldehyde additive. Generally, these compounds may have the general formula:

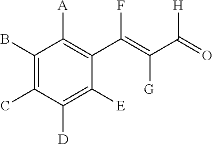

where A-E are selected from a group consisting of hydrogen, halides, alkyl, alkoxy, amino, nitro and hydroxyl and F and G are selected from a group consisting of hydrogen, halides and alkyl. In an alternative embodiment, at some low pH conditions, the cinnamaldehyde additives may be in the form of an acetal or a hemiacetal having the general formula:

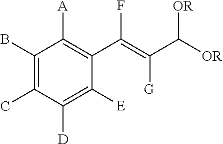

wherein A-E are selected from a group consisting of hydrogen, halides, alkyl, alkoxy, amino, nitro and hydroxyl, and F and G are selected from a group consisting of hydrogen, halides and alkyl. In this embodiment, the R is selected from the group consisting of hydrogen, alkyl, alkaline metal cation and alkaline earth cation.

More specifically, the cinnamaldehyde additive may, in some embodiments, be selected from the group of compounds represented by the general formula:

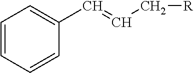

wherein R is a hydroxyl alkyl, carboxylic acid group, or an aldehyde group. The R groups may also include amino and nitro groups. Exemplary compounds include, but are not limited to:

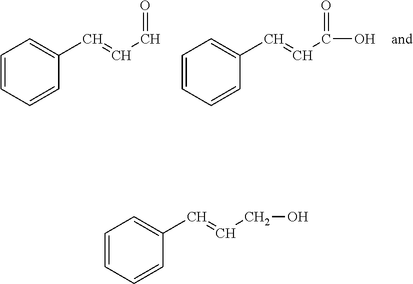

Other compounds that may be used in certain embodiments of the disclosure include, but are not limited to: cinnamyl acetate, 3-phenylpropionaldehyde, 2-bromocinnamaldehyde, phenyl propiolic aldehyde, benzalacetone, ethyl cinnamate, 4-chlorocinnamaic acid, 4-nitrocinnamaic acid, and 4 aminocinnamic acid.

Cinnamaldehyde may be extracted from the dried aromatic inner bark of certain tropical Asian trees in the genus Cinnamomum, especially C. verum and C. loureirii. It may also be produced synthetically. For the purposes of this application, the cinnamaldehyde additives of the application may also include other compounds extracted from biological sources (or their synthetic analogs): including vanillin (extracted from vanilla beans; genus Vanilla, especially V. planifolia), eugenol (extracted from the buds of cloves; Syzygium aromaticum), and capsaicin (extracted from hot peppers; genus Capsicum, especially the species C. annuum and C. frutescens).

The cinnamaldehyde additives of the disclosure may combine with conventional biocides to produce synergistic improvement to the ability of a conventional biocide to mitigate the formation of sulfate reducing bacteria and other forms of biofouling organisms. In some embodiments, the weight ratio of conventional biocide to cinnamaldehyde additive may be from about 1:10 to about 1:1. In other embodiments the ratio may be from about 1:8 to about 1:2. The still other embodiments the ratio may be from about 1:5 to about 1:3.

While the cinnamaldehyde additives of the application maybe synergistically combined with other types of compounds, in some applications the cinnamaldehyde additives added by themselves may be useful in preventing or mitigating biofouling. The advantages of using a cinnamaldehyde additive alone, that is without neither a conventional biocide nor a synergistic component, are significant. For example, one need not worry about undesirable interactions between the cinnamaldehyde additive and a synergistic or biocidal component.

Since the cinnamaldehyde additives of the application may be used with many types of conventional biocides, one of ordinary skill in the art employing an embodiment of the method of the disclosure may be required to determine the best ratio of cinnamaldehyde additive to conventional biocide, as well as optimal dosage for their application. Those of ordinary skill in the art well know how to do this.

The biocide compositions of the disclosure may additionally include other compounds and compositions. For example, the biocide compositions of the disclosure may include dispersants, solubilizers, stabilizers, winterizers and the like.

The compositions of the disclosure may be prepared using any method known to be useful to those of ordinary skill in the art of preparing such compositions. In one embodiment, the cinnamaldehyde additive and the conventional biocide are admixed prior to shipping to a consumer. In another embodiment, where the conventional biocide and a cinnamaldehyde additive are not compatible, the composition may be sent as two components and admixed immediately prior to use.

While the compositions and methods of the disclosure are directed to their use as biocides, in some embodiments, they are directed primarily at use as a bactericide. In some embodiment, these compositions and methods are specifically not directed at use as a fungicide. In some applications they are also not intended for use on crops or in potable water.

In addition to being effective as a biocide, the cinnamaldehyde additives may also be employed in oilfield operations to treat completion fluids and production fluids. For the purposes of this application, a completion fluid is a fluid employed downhole to finish or “complete” an oil well to enable it to begin producing “production fluid.” These fluids are typically low-solids fluid or drilling mud that are selected for their ability to control formation pressure and minimize formation damage. “Production fluid” is the fluid that taken from the formation and typically includes brine, natural gas, and crude oil; as well as the other components recovered from an underground formation.

Cinnamaldehyde additives of the application may be used for dispersing biofilms, and stabilizing compositions including gels, friction reducers, and completions fluids. Gels are used to transport proppants during well stimulation. These gels are subject to breaking down and thereby failing to perform their desired function. The cinnamaldehyde additives of the application may be employed to extend the life and/or improve the function of such gels.

During an oil well stimulation project a fluid, usually water, may be injected/pumped into an oil well very rapidly to among other things, fracture part of a geological formation. The cinnamaldehyde additives of the application may be employed to reduce the friction of the fluid injection by extending the life and/or improve the function of conventionally applied friction reducing compounds.

Biofilms may still be a problem downhole even after the living part of the film has expired. The cinnamaldehyde additives of the application may be employed downhole to disperse such films. These additives may, in some applications, be effective in causing such films to release from their substrates and sometimes even further disperse to reduce subsequent particle size after release.

Stabilization can, in some applications, mean to cause at two components to remain in a single phase. The cinnamaldehyde additives of the application can be employed to stabilize by compatibilizing compositions that might otherwise phase out from the fluid in which they are employed. For example, these additives may be employed in the case of production fluid to compatibilize the hydrophobic and hydrophilic components of completion fluids so that they remain in a single phase. They may be further employed to compatibilize a friction reducer with production fluid or even a separated crude oil stream.

### EXAMPLES

The following examples are provided to illustrate the present invention. The examples are not intended to limit the scope of the present invention and they should not be so interpreted. Amounts are in weight parts or weight percentages unless otherwise indicated.

### Example 1

Water samples containing biofouling bacteria, in this particular case, sulfate-reducing bacteria (SRB), were used to test for synergism of cinnamaldehyde with tetrakis hydroxymethyl phosphonium sulfate (THPS). The samples were treated with different concentrations of THPS in combination with different concentrations of cinnamaldehyde and incubated for 3 hours. Following the treatment, an aliquot of each sample was serially diluted (10-fold dilutions) into culture media for SRB to enumerate the survivors according to NACE TMO 194-2004. The results are presented in Table 1 below:

TABLE 1

| THPS | Cinnamaldehyde | SRB¹ Surviving |
|---|---|---|
| Concentration | Concentration | Treatment |
| (ppm) | (ppm) | (SRB/ml) |
| 0 | 0 | ≧10¹⁰ |
| 50 | 0 | ≧10¹⁰ |
| 100 | 0 | ≧10¹⁰ |
| 250 | 0 | 10⁵ |
| 0 | 25 | ≧10¹⁰ |
| 50 | 25 | ≧10¹⁰ |
| 100 | 25 | ≧10¹⁰ |
| 250 | 25 | 10⁴ |
| 0 | 50 | ≧10¹⁰ |
| 50 | 50 | ≧10¹⁰ |
| 100 | 50 | 10⁵ |
| 250 | 50 | 10² |

¹SRB refers to sulfate-reducing bacteria

This test clearly shows that even at very low concentrations, cinnamaldehyde improves the ability of THPS to inhibit the growth of sulfate reducing bacteria.

### Example 2

A sample of a bacterial fouled water was taken from an oil production site and used as a culture base for testing of cinnamaldehyde as a bactericide. The culture was introduced into a synthetic brine (similar to that used for oilfield operations) and turbidity was measure at 600 nm after 24 hours. The results are shown below in Table 2.

TABLE 2

| Cinnamaldehyde Concentration | |
|---|---|
| (ppm) | Turbidity |
| 0 | 2.098 |
| 50 | 1.854 |
| 125 | 0.973 |
| 250 | 0.175 |
| 375 | 0.103 |
| 500 | 0.113 |

What is claimed is:

1. A process for preventing or mitigating the occurrence of biofouling comprising introducing a cinnamaldehyde additive into an industrial water system as a biocide.

2. The process of claim 1 further comprising introducing a conventional biocide into the industrial water system.

3. The process of claim 1 further comprising introducing an inert synergistic component into the industrial water system.

4. The process of claim 1 wherein the cinnamaldehyde additive is introduced into an industrial water system in the substantial absence of a conventional biocide and/or an inert synergistic component.

5. The process of claim 1 wherein the industrial water system is selected from the group consisting of:
a cooling water system, especially those systems that include cooling towers;
an industrial cleaning process water system; and
a process water preparation system.

6. The process of claim 1 wherein the industrial water system is selected from water systems used in the field of exploration for and production of oil and gas selected from the group consisting of:
aqueous drilling fluids,
fluids used for secondary and tertiary recovery, and
fracture fluids.

7. The process of claim 1 wherein the cinnamaldehyde additive comprises at least one compound having the general formula: 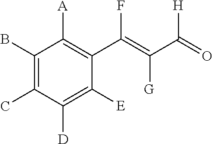
where A-E are selected from a group consisting of hydrogen, halides, alkyl, alkoxy, amino, nitro and hydroxyl, and F and G are selected from a group consisting of hydrogen, halides and alkyl.

8. The process of claim 7 wherein, under low pH conditions, the cinnamaldehyde additives may be in the form of an acetal or a hemiacetal.

9. The process of claim 1 wherein the cinnamaldehyde additive is selected from the group consisting of: cinnamaldhydecinnamyl acetate, 3-phenylpropionaldehyde, 2-bromocinnamaldehyde, phenyl propiolic aldehyde, benzalacetone, ethyl cinnamate, 4-chlorocinnamaic acid, 4-nitrocinnamaic acid, and 4 aminocinnamic acid, vanillin, capsaicin, eugenol, and combinations thereof.

10. The process of claim 2 wherein the conventional biocide is oxidizing and is selected from the group consisting of: chlorine gas, hypochlorous acid, hypobromous acid, trichloroisocyanuric acid, sodium bromide, chlorinated isocyanurates, hypochlorites, chlorinated hydantoins, and combinations thereof.

11. The process of claim 2 wherein the conventional biocide is non-oxidizing and is selected from the group consisting of:
quaternary ammonium compounds;
thiocarbamates;
dithiocarbamates;
thiocyanates;
hydroxyalkylaminoalkanols;
formaldehyde;
p-formaldehyde;
glutaraldehyde;
isothiazolin-3-ones;
complexed copper;
metaborate;
sodium dodecylbenzene sulphonate;
sodium benzoate;
thione;
tetrakis(hydroxymethyl)phosphonium sulfate (THPS);
chloromethylphenol; and
combinations thereof.

12. The process of claim 3 wherein the inert synergistic component is selected from the group consisting of: sodium nitrite, sodium molybdate, anthraquinone, and mixtures thereof.

13. The process of claim 1 wherein the cinnamaldehyde additive additionally functions to disperse biofilms.

14. A composition useful for preventing or mitigating biofouling in an industrial water system comprising a cinnamaldehyde additive and a conventional biocide.

15. The composition of claim 14 wherein the cinnamaldehyde additive comprises at least one compound having the general formula: 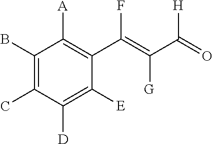
where A-E are selected from a group consisting of hydrogen, halides, alkyl, alkoxy, amino, nitro and hydroxyl, and F and G are selected from a group consisting of hydrogen, halides and alkyl.

16. The composition of claim 14 wherein the cinnamaldehyde additive is selected from the group consisting of: cinnamaldhydecinnamyl acetate, 3-phenylpropionaldehyde, 2-bromocinnamaldehyde, phenyl propiolic aldehyde, benzalacetone, ethyl cinnamate, 4-chlorocinnamaic acid, 4-nitrocinnamaic acid, and 4 aminocinnamic acid, vanillin, capsaicin, eugenol, and combinations thereof.

17. A composition useful for preventing or mitigating biofouling in an industrial water system comprising a cinnamaldehyde additive and an inert synergistic component.

18. The composition of claim 17 wherein the wherein the cinnamaldehyde additive comprises at least one compound having the general formula: 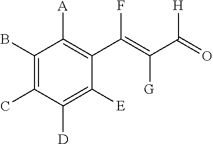
where A-E are selected from a group consisting of hydrogen, halides, alkyl, alkoxy, amino, nitro and hydroxyl, and F and G are selected from a group consisting of hydrogen, halides and alkyl.

19. The composition of claim 17 wherein the cinnamaldehyde additive is selected from the group consisting of: cinnamaldhydecinnamyl acetate, 3-phenylpropionaldehyde, 2-bromocinnamaldehyde, phenyl propiolic aldehyde, benzalacetone, ethyl cinnamate, 4-chlorocinnamaic acid, 4-nitrocinnamaic acid, and 4 aminocinnamic acid, vanillin, capsaicin, eugenol, and combinations thereof.

20. The composition of claim 17 wherein the inert synergistic component is selected from the group consisting of: sodium nitrite, sodium molybdate, anthraquinone, and mixtures thereof.

21. A process for treating a completion or production fluid comprising introducing a cinnamaldehyde additive into the completion or production fluid wherein the cinnamaldehyde additive functions to compatibilize:
the phases of the completion or production fluid,
a friction reducer with a production fluid, and
combinations thereof.
